(19) United States
(12) Patent Application Publication
(10) Pub. No.: US 2004/0203975 A1
(43) Pub. Date: Oct. 14, 2004

(54) REMOTE CONTROL FOR A CELLULAR PHONE

(76) Inventors: Kun-Huei Chen, Taipei Hsien (TW); Hsin-Chin Liao, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,123

(22) Filed: Mar. 18, 2003

(51) Int. Cl. H04Q 7/20; H04B 1/38; H04M 3/42

(52) U.S. Cl. 455/517; 455/566; 455/66.1; 455/414.1

(57) ABSTRACT

A method is used for remotely controlling operations of a cellular phone with a control device, which can be detachably connected to the cellular phone. The cellular phone operates according to a control signal emitted by the control device, and transmits a corresponding response signal back to the control device. The method includes providing the control device with a control panel, utilizing the control panel to generate the control signal, transmitting the control signal to the cellular phone, receiving the corresponding response signal from the cellular phone with the control device, and providing the control device with a speaker.

### BACKGROUND OF INVENTION

1. Field of the Invention

The invention relates to a method for controlling a cellular phone, and more particularly, to a method for remotely controlling a cellular phone with a control device.

2. Description of the Prior Art

Cellular phones have become more and more popular in recent years. Powerful and delicate cellular phones constantly come to the public for fulfilling the demands of the consumers. With more additional items and functions provided by the cellular phones, users can acquire more convenience of life. By using a state-of-the-art cellular phone, users can easily deliver text and graphic messages to another user, browse Internet web pages, transmit/receive e-mails, receive AM/FM broadcasts, and even record/play music. However, in spite of the great diversity and convenience of the commercialized cellular phones, there still exists a disadvantage concerning those delicate cellular phones. When a user wants to make use of those additional items and functions besides not including the fundamental dialing function, they have to take the whole cellular phone, even though most of those additional items and functions are only related to a small part of the keypads of the cellular phone. Therefore, those additional items and functions cannot be performed when the user is not available to carry the whole cellular phone by hand. In addition, some specific functions, which are designed for operating in private such as recording, cannot be applied if the user cannot carry the whole cellular phone by hand when performing those specific functions.

Nowadays, there are some commercialized remote control devices for the cellular phones so that the users can answer the phone calls without carrying the cellular phones by hand. However, the remote control devices purely for answering phones are insufficient for the users. Besides, the remote control devices of the prior art only perform a one-way control process. For example, after the user hears the ringing bell of the cellular phone and triggers the remote control device, a one-way control signal can be emitted from the remote control device to the cellular phone for the user to answer the phone. The one-way control process of the prior art leaves a lot of space for improvement.

### SUMMARY OF INVENTION

It is therefore a primary objective of the claimed invention to provide a method for remotely controlling a cellular phone with a control device and to solve the above-mentioned problems.

The claimed invention provides a method for remotely controlling a cellular phone with a control device,the control device detachably installed on the cellular phone, the cellular phone operating according to a control signal emitted from the control device, and then transmitting a response signal corresponding to the control signal to the control device after receiving the control signal. The method comprises providing the control device with a control panel, utilizing the control panel to generate the control signal, transmitting the control signal to the cellular phone, utilizing the control device to receive the response signal corresponding to the control signal from the cellular phone, and providing the control device with a speaker.

According to the claimed invention, a control device for remotely controlling a cellular phone is provided. The control device is detachably installed on the cellular phone, the cellular phone operating according to a control signal emitted from the control device, and transmitting a response signal related to the control signal to the control device after receiving the control signal. The control device comprises a microprocessor for processing data, a plurality of input buttons electrically connected to the microprocessor for generating a plurality of input signals, a connecting port electrically connected between the control device and the cellular phone for transmitting the control signal to the cellular phone and for receiving the response signal, and a speaker connecting port electrically connected to a speaker for transmitting an audio signal.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of a control device according to the present invention.

FIG. 2 is a schematic diagram of a transmission connector as shown in FIG. 1.

FIG. 3 is a flowchart of a first embodiment showing operation of the control device of the present invention.

FIG. 4 is a flowchart of a second embodiment showing operation of the control device of the present invention.

### DETAILED DESCRIPTION

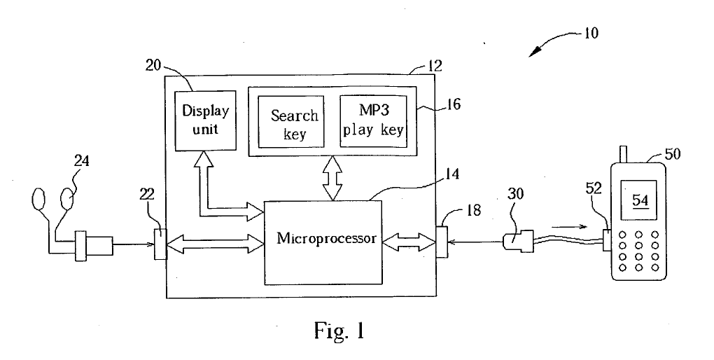

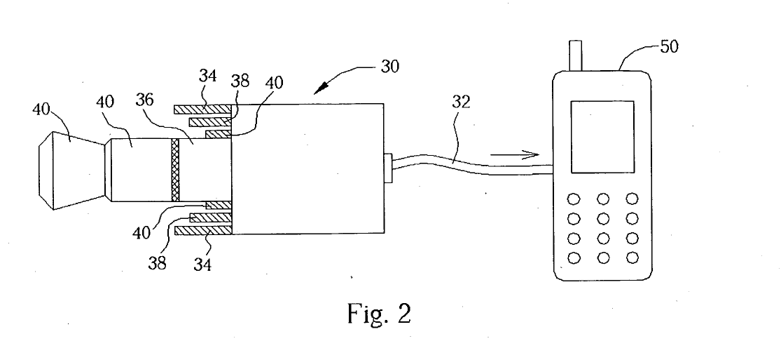

Please refer to FIG. 1, which is a schematic diagram of a control device 10 according to the present invention. Please also refer to FIG. 2, which is a schematic diagram showing a transmission connector 30 of the control device 10 as shown in FIG. 1. The control device 10 includes a housing 12, a microprocessor 14 installed in the housing 12 for controlling operations of the control device 10, and a plurality of input buttons 16 installed on the housing 12 and electrically connected to the microprocessor 14 for allowing users to input signals. The control device 10 further includes a connecting port 18, a display unit 20, and a speaker connecting port 22. As shown in FIG. 1, the connecting port 18 that is electrically connected to a transmission connector 30 lies in one side of the control device 10. As shown in FIG. 2, the transmission connector 30 comprises a transmission line 32, a data transmission section 34, a control transmission section 36, a power transmission section 38, and an audio transmission section 40. The control device 10 can make use of the connecting port 18 combined with the transmission connector 30 to connect to a cellular phone 50. The above-mentioned various transmission sections of the transmission connector 30 are divided according to various types of data being transmitted. A data signal from the cellular phone 50 can be transmitted to the control device 10 via the data transmission section 34 of the transmission connector 30; a control signal from the cellular phone 50 can be transmitted to the control device 10 via the control transmission section 36 of the transmission connector 30; the power transmission section 38 can receive the power from the cellular phone 50 for operating the control device 10 so that the control device 10 requires no external power suppliers or batteries; and an audio signal from the cellular phone 50 can be transmitted to the control device 10 via the audio transmission section 40 of the transmission connector 30.

As shown in FIG. 1, the control device 10 can be detachably connected to the cellular phone 50 for remotely controlling the cellular phone 50. When the user would like to remotely perform partial functions of the cellular phone 50 without taking out the cellular phone 50, the user can connect the transmission connector 30 that is connected to the connecting port 18 of the control device 10 to an external connector 52 of the cellular phone 50 so as to connect the control device 10 to the cellular phone 50. After that, a control microprocessor 54 of the cellular phone 50 is electrically connected to the microprocessor 14 of the control device 10. Therefore, the microprocessor 14 of the control device 10 can transmit signals to the control microprocessor 54 of the cellular phone 50 to control operations of the control microprocessor 54. Similarly, the control microprocessor 54 of the cellular phone 50 can transmit signals to the microprocessor 14 of the control device 10 to control operations of the microprocessor 14. Moreover, the control device 10 can make use of the speaker connecting port 22 to allow the user to listen to broadcasts or music from the cellular phone 50. The user can operate the control device 10 to listen to radio programs or music by plugging stereos or earphones into the speaker connecting port 22. Via a plurality of the input buttons 16, the user can control the microprocessor 14 to generate the control signal for controlling operations of the control device 10. In addition, the display unit 20 of the control device 10 can display messages transmitted from the control microprocessor 54 of the cellular phone 50 for providing the user with related visual information.

Please continue referring to FIG. 1 and FIG. 2. For instance, if the cellular phone 50 allows the user to listen to radio programs or music, the user can make use of the control device 10 to adjust the sound volume and radio frequency. Corresponding input signals are generated from the microprocessor 14 after the user triggers a plurality of the input buttons 16. After that, the control device 10 will transmit the corresponding control signal to the cellular phone 50. The cellular phone 50 will operate according to the control signal from the control device 10, and transmit a response signal related to the control signal to the control device 10. The response signal from the cellular phone 50 comprises a display signal for displaying conditions of the cellular phone 50. Essential adjusting information related to the control device 10 and the cellular phone 50 will be displayed on the display unit 20 of the control device 10. The speaker connecting port 22 can be connected to a speaker 24 for transmitting audio information. For instance,the speaker connecting port 22 is designed as an earphone plug, and speaker 24 is an earphone, so that the user can listen to music or broadcasts via the speaker connecting port 22 and the speaker 24.

For another instance, if the speaker connecting port 22 is designed as a microphone plug, and the speaker 24 is a microphone, the user can operate recording with the control device 10 via the speaker connecting port 22 and the speaker 24.

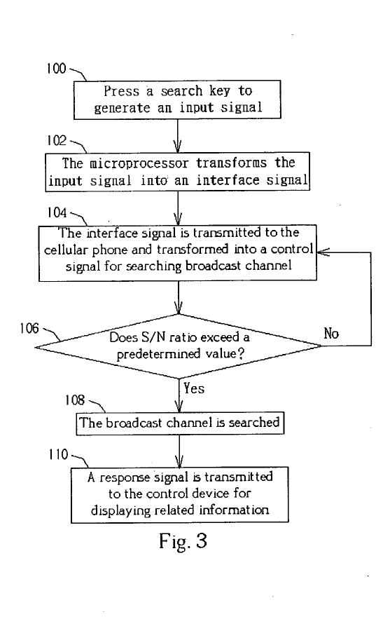

Please refer to FIG. 3, which is a flowchart of the first embodiment showing operation of the control device 10. The first embodiment emphasizes how the user operates broadcast-channel searching with the control device 10. The first embodiment comprises following steps:

Step 100: The user press a search key of the plurality of the input buttons 16 and then an input signal is generated;

Step 102: After the microprocessor 14 of the control device 10 receives the input signal, the microprocessor 14 will transform the input signal into an interface signal that can be accepted by the connecting port 18 and the transmission connector 30;

Step 104: Via the connecting port 18 and transmission connector 30, the interface signal is transmitted to the cellular phone 50. The cellular phone 50 then transforms the interface signal into a control signal and transmits the control signal to a chipset module of the cellular phone 50. The chipset module of the cellular phone 50 will search the broadcast channel according to the control signal;

Step 106: The chipset module of the cellular phone 50 will identify an S/N ratio of the searched broadcast channel. If the S/N ratio exceeds a predetermined value, proceed to step 108, otherwise proceed to step 104;

Step 108: The chipset module of the cellular phone 50 succeeds in searching the broadcast channel;

Step 110: The chipset module of the cellular phone 50 transmits a response signal related to the control signal and the searched broadcast channel to the control device 10. All the related information will be displayed on the display unit 20 of the control device 10.

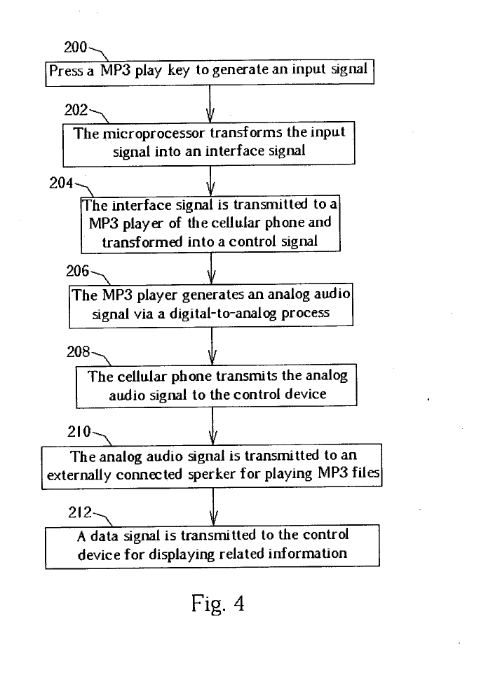

Please refer to FIG. 4, which is a flowchart of the second embodiment showing operation of the control device 10. The second embodiment emphasizes how the user plays MP3 files via the control device 10. The second embodiment comprises steps:

Step 200: The user press an MP3 play key of the plurality of the input buttons 16 and then an input signal is generated;

Step 202: After the microprocessor 14 of the control device 10 receives the input signal, the microprocessor 14 will transform the input signal into an interface signal that can be accepted by the connecting port 18 and the transmission connector 30;

Step 204: Via the connecting port 18 and transmission connector 30, the interface signal is transmitted to the cellular phone 50. The cellular phone 50 then transforms the interface signal into a control signal and transmits the control signal to an MP3 player of the cellular phone 50;

Step 206: The MP3 player of the cellular phone 50 delivers an analog audio signal related to the control signal via a digital-to-analog process;

Step 208: The cellular phone 50 transmits the analog audio signal to the control device 10 via the transmission connector 30 and the connecting port 18;

Step 210: The microprocessor 14 of the control device 10 transmits the analog audio signal to the speaker connecting port 22, and the user can listen to the MP3 files after the speaker 24 is connected to the speaker connecting port 22;

Step 212: The MP3 player of the cellular phone 50 also transmits a data signal related to the analog audio signal to the control device 10 so that the related information, such as titles of the MP3 files, will be displayed on the display unit 20 of the control device 10.

In contrast to the prior art,the present invention provides a method with a control device for remotely controlling operations of a cellular phone. The method provides two-way control processes. That is, signals and data can dually transmitted and processed between the cellular phone and the control device. Via remote connection between the control device and the cellular phone, the control device can control operations of the cellular phone,and receive and process corresponding response from the cellular phone to enhance the functions of the cellular phone. In addition, with the control device, the user can operate specific functions in private, such as recording, to bring the functions of the cellular phone into full play.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for remotely controlling a cellular phone with a control device, the control device detachably installed on the cellular phone, the cellular phone operating according to a control signal emitted from the control device, and then transmitting a response signal corresponding to the control signal to the control device after receiving the control signal, the method comprising:
providing the control device with a control panel;
utilizing the control panel to generate the control signal;
transmitting the control signal to the cellular phone;
utilizing the control device to receive the response signal corresponding to the
control signal from the cellular phone; and
providing the control device with a speaker.

2. The method of claim 1 wherein the speaker is an earphone or a microphone.

3. The method of claim 1 wherein the control signal is used for controlling the cellular phone to play MP3 files, and the response signal corresponds to a related message transmitted from the cellular phone that plays the MP3 files.

4. The method of claim 1 wherein the control signal is used for controlling the cellular phone to play an RF program, and the response signal corresponds to a related message transmitted from the cellular phone that plays the RF program.

5. The method of claim 1 wherein the control signal is used for controlling the cellular phone to dial a phone number, and the response signal corresponds to a related message transmitted from the cellular phone that performs the phone dialing.

6. The method of claim 1 wherein the response signal comprises a display signal, the method further comprising:
providing the control device with a display unit; and
displaying the display signal on the display unit.

7. The method of claim 6 wherein the display unit is a liquid crystal display (LCD).

8. The method of claim 1 further comprising:
providing a transmission connector;
wherein the transmission connector is detachably connected to the connecting port, the control signal is transmitted to the cellular phone via the transmission connector, and the response signal is transmitted to the control device via the transmission connector.

9. The method of claim 8 wherein the transmission connector comprises a data transmission section, and a data signal of the response signal is transmitted to the control device via the data transmission section of the transmission connector.

10. The method of claim 8 wherein the transmission connector comprises a control transmission section, and the control signal is transmitted to the control device via the control transmission section of the transmission connector.

11. The method of claim 8 wherein the transmission connector comprises a power transmission section for providing electric power to the control device.

12. The method of claim 8 wherein the transmission connector comprises an audio transmission section, and an audio signal of the response signal is transmitted to the control device via the audio transmission section of the transmission connector.

13. A control device for remotely controlling a cellular phone, the control device detachably installed on the cellular phone, the cellular phone operating according to a control signal emitted from the control device, and transmitting a response signal related to the control signal to the control device after receiving the control signal, the control device comprising:
a microprocessor for processing data;
a plurality of input buttons electrically connected to the microprocessor for generating a plurality of input signals;
a connecting port electrically connected between the control device and the cellular phone for transmitting the control signal to the cellular phone and for receiving the response signal; and
a speaker connecting port electrically connected to a speaker for transmitting an audio signal.

14. The control device of claim 13 wherein the speaker is an earphone or a microphone.

15. The control device of claim 13 wherein the control signal is used for controlling the cellular phone to play MP3 files, and the audio signal corresponds to the response signal that is transmitted from the cellular phone to the control device.

16. The control device of claim 13 wherein the control signal is used for controlling the cellular phone to play an RF program, and the audio signal corresponds to the response signal that is transmitted from the cellular phone to the control device.

17. The control device of claim 13 further comprising a display unit for displaying a display signal of the response signal.

18. The control device of claim 13 further comprising a transmission connector detachably connected to the connecting port, wherein the control signal is transmitted to the cellular phone via the transmission connector, and the response signal is transmitted to the control device via the transmission connector.
